(19) United States
(12) Patent Application Publication
(10) Pub. No.: US 2015/0092396 A1
(43) Pub. Date: Apr. 2, 2015

(54) ILLUMINATED DEVICE

(71) Applicant: Joseph Jordan, Studio City, CA (US)

(72) Inventor: Joseph Jordan, Studio City, CA (US)

(21) Appl. No.: 14/504,211

(22) Filed: Oct. 1, 2014

Related U.S. Application Data
(60) Provisional application No. 61/885,395, filed on Oct. 1, 2013.

(51) Int. Cl. A47G 19/22; F21V 23/00; F21V 19/00

(52) U.S. Cl. CPC A47G 19/2227; F21V 19/001; F21V 23/003; A47G 2019/2238
USPC 362/101; 29/428

(57) ABSTRACT

There is disclosed an illuminating device for an object, such as a bottle. The illuminating device may include one or more LEDs that may be programmed to blink randomly or in a predetermined sequence. The illuminating device may be attached or integrated into a bottom portion of the bottle into a cavity with a divot. Such a configuration provides stability for the bottle and does not interfere with its functionality.

The present invention claims priority to provisional application No. 61/885,395 filed on Oct. 1, 2013, which is hereby incorporated by reference in its entirety.

### BACKGROUND OF THE INVENTION

1. Field of the Invention

The present invention to relates to an object that may be illuminated by an electronic device integrally molded with or attached to the device.

2. Background

Many forms of illumination exist that are capable of illuminating an object, such as a bottle or can. The known forms of illumination suffer from several drawbacks. For example, illuminating devices and systems do not allow for enhanced interactivity between the user of the bottle and the illumination source. Rather, known systems merely turn off and on a single source of light. Further, known illumination devices do not provide adequate stability to the bottle or can, thereby making consuming the contents of the bottle and/or can difficult. Additionally, no consideration has been given to the placement or configuration of a power source relative to the lighting source and the activation source to take advantage of cost, look and feel, power consumption, utility, and/or the functionality of the illuminating device when attached or integrated with the device.

Therefore, there is a need for an illumination device that may be configured for use with an object that solves the aforementioned problems.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### SUMMARY OF THE INVENTION

In one embodiment, a device and/or method includes an object configured to store a liquid for drinking, the object including a recessed cavity at one end and further including an illuminating device one of attached and integrated into the cavity for lighting the liquid inside the object. The illuminating device comprises one or more LEDs that are configured to be activated by an activation device. The one or more LEDs are activated by one of pressure, light, sound, the angle of the object, temperature, wireless, voice, and radio control. The illuminating device is attached to the object by one of adhesive, snapped or locked into place by complimenting nodes or nodules, screwed into place, bundled or held in place by an adhesive film or tape, bonded by heating, fastened into place with nylon plastic straps, wire, and string. The illuminating device is formed onto or integrated with the object as part of a molding process. The illuminating device protrudes from the cavity. The illuminating device is recessed in the cavity. The activation device is activated by one of remote control, one or more sensors, and position. The activation device is activated by one of acoustic, sound, vibration, optical light, motion, seismic, shock, environmental, moisture, temperature, fluid velocity, angle displacement, distance, speed, and acceleration. The one or more LEDs are configured to one of remain in an on state indefinitely, until the power source expires, be turned off and on by an activation, and programmed to blink in a random or predetermined sequence.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates an example of an object, such as a bottle, in an embodiment.

FIG. 2 illustrates an example of an illuminating device

FIGS. 3(A)-3(C) illustrate a perspective view of the bottom portion of a bottle configured for an illuminating device.

### DETAILED DESCRIPTION

Each of the additional features and teachings disclosed below can be utilized separately or in conjunction with other features and teachings to provide a device, system, and/or method for illuminating an object, such as a bottle or can. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for an illuminating device for an object. The object may be a bottle, can, drink dispenser carton, jar, canister or other device for receiving content and/or enabling a user to dispense content. An illuminating device may be integrated with or attached to one more parts of the object to illuminate the object. In one embodiment, the illuminating device is attached to the object by adhesive, snapped or locked into place by complimenting nodes or nodules, screwed into place, bundled or held in place by an adhesive film or tape, bonded by heating, fastened into place with nylon plastic straps, wire, or string or similar method. In another embodiment, the illuminating device is formed onto or integrated with the object as part of a molding process. Suitable molding processes include blow molding, rotational molding, extrusion molding, injection molding, two-piece molding, or other similar techniques.

In one embodiment, a power source, one or more resistors, LED(s), a processor/controller and a method of activation may be contained on an integrated circuit board. The power source may include a battery cell configured with two conducting metal tabs which may be soldered to the board. In one embodiment, a 7.5 mm wafer switch may be configured to facilitate the on/off function and other modules by interrupting the flow of electric current between the battery cell and the processor. The processor may regulate the flow of electric current permitted to flow through the integrated circuits and into the LEDs, administer the variety of features including blinking, LED brightness and any one of another pre-programmed illumination patterns.

In one example, the illuminating device may be configured to attach or integrate into a recessed cavity formed into a bottom portion of the object. In one example, the illuminating device is configured to attach or integrate into a recessed cavity formed into a bottom portion of the object, where the cavity has a divot. In another example, the illuminating device has substantially the same shape as the recessed cavity. In another example, the illuminating device is configured to fit with a suitable height and width into the recessed cavity.

In another embodiment, the illuminating device provides a stable or level surface for the object to be placed on. In yet another embodiment, the illuminating device is configured so that one or electronic elements is hidden from external view.

The illuminating device may include one or more light emitting diodes (LED) that may remain in an on state indefinitely or until the power source expires, be turned off and on by an activation device, such as a switch, button, or may be programmed to blink in a random or predetermined sequence, or be any combination of the above. The activation device may be activated by remote control or various sensors, such as acoustic, sound, vibration, optical light, motion, seismic, shock, environmental, moisture, temperature, fluid velocity, or position, such as angle displacement, distance, speed, or acceleration. The number of LEDs may range from one to six or more.

The LEDs may be activated by pressure, light, sound, the angle of the object, temperature, wireless, and/or radio control. The LEDs may also provide an interactive experience due the ability to program the LEDs or design them for a particular application. For example, the LEDs may be voice activated or blink in accordance with music or other prompt. The power source may be a battery, primary cell non-rechargeable battery or a secondary cell rechargeable battery. The LEDs may be any color and the illuminating device may be formed in one of several shapes including exactly, approximately or substantially square, rectangular, circular, ovular, or other suitable shape. The illuminating device may have dimensions of proportional to the size and shape of the container. In one embodiment, a diameter width of the device may be about the width of the container or less measured at its widest point. The maximum height or thickness of the device may be about the depth of the cavity.

In one embodiment, the power source may be positioned substantially opposite the activation source. In this way, the battery provides a suitable opposing force to activate the activation source and prevent damage to the illuminating device. In one example, the LEDs may be configured in a substantially circular arrangement around the battery, substantially horizontally and vertically along the perimeter of the module, or substantially arranged in multiple rows around a circumference or perimeter.

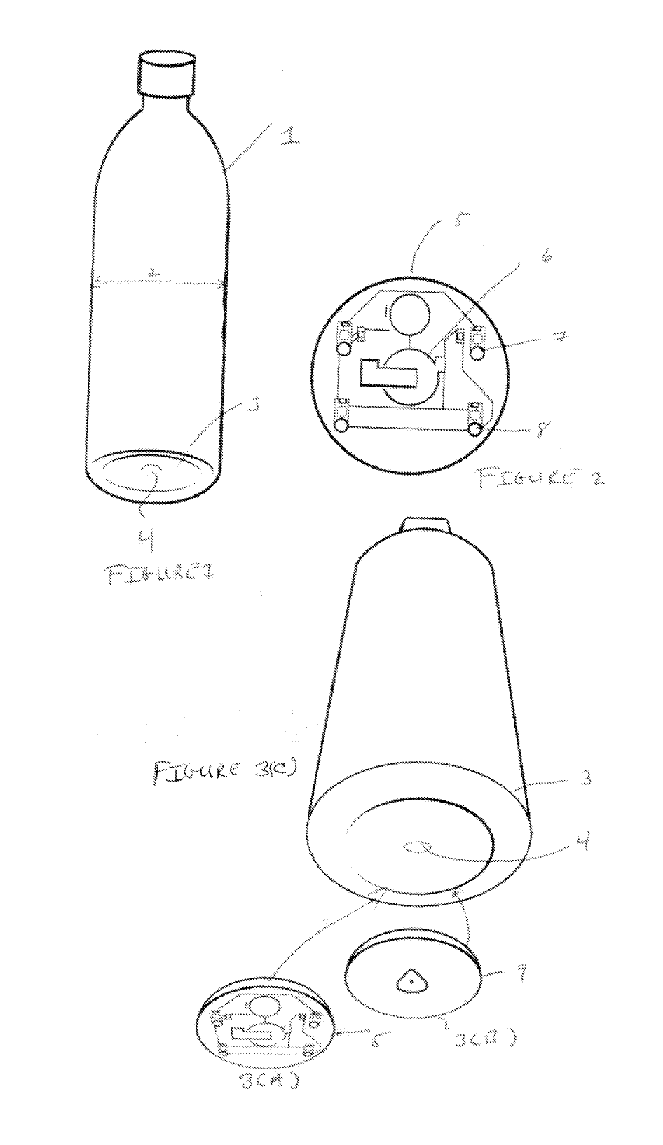

FIG. 1 illustrates an example of an object in an embodiment. The object may be configured in any size or shape. The object may also be formed in part or entirely of a light transmissive material. In one embodiment, the object may be a bottle 1 having a substantially cylindrical shape and formed from air-blown recyclable plastic. The bottle 1 may have any suitable internal diameter. In one embodiment, the diameter 2 of the bottle 1 may be approximately 200 mm. In other embodiments, the diameter may be between approximately 20 mm-100 mm, the cavity depth may be 4 mm-20 mm, and a divot depth range 1.5 mm-10 mm. At an end of the bottle 1 may be a recessed cavity 3. The depth of the cavity 3 may be any suitable depth to accommodate the illuminating device. The cavity 3 may further include a further recession or divot 4. The divot may have the substantially the same, exactly the same, or different shape from the cavity 3. In one embodiment, the divot 4 may have a depth of approximately 5 mm.

.FIG. 2 illustrates an example of an illuminating device 5. The device 5 may have a diameter suitable to be configured into the cavity 3 and/or divot 4 or some combination thereof. The device 5 may have a diameter of approximately between 15 mm-90 mm. In one embodiment, the diameter of the device 5 is approximately 35 mm.

The illuminating device 5 may include a power source 6. In one embodiment, the source 6 is a battery that is substantially the same size as the divot 4. One or more LEDs 7, 8 may be substantially equally spaced around the battery such that the combination of the LEDs 7, 8 and the power source 6 provide stability or to provide a substantially even surface to the object.

FIGS. 3(A)-(C) illustrates a perspective view of the bottom portion of a bottle 1 configured for an illuminating device 5. As shown, the illuminating device 5 (FIG. 3A) may be configured to be integrated into and/or attached to the bottom portion of the bottle one into the cavity 3 and divot 4, such that the illuminating device fits securely. A cover 9 or similar device may be used to enclose the illuminating device 5. The cover 9 may be substantially the same size and depth as the illuminating device. In one embodiment, the illuminating device does not extend beyond the cavity. In another embodiment, the illuminating device may protrude from the cavity.

The described devices, systems and methods have minimal power requirements, no electric cables or complex machinery, low cost construction, and improved stability as compared to other illuminating devices. The illuminating device 5 may be attached or integrated into a standard commercial object, such as bottle.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . . ”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A device, comprising:
an object configured to store a liquid for drinking, the object including a recessed cavity at one end and further including an illuminating device one of attached and integrated into the cavity for lighting the liquid inside the object.

2. The device of claim 1, wherein the illuminating device comprises one or more LEDs that are configured to be activated by an activation device.

3. The device of claim 1, wherein the one or more LEDs are activated by one of pressure, light, sound, the angle of the object, temperature, wireless, voice and radio control.

4. The device of claim 1, wherein the illuminating device is attached to the object by one of adhesive, snapped or locked into place by complimenting nodes or nodules, screwed into place, bundled or held in place by an adhesive film or tape, bonded by heating, fastened into place with nylon plastic straps, wire, and string.

5. The device of claim 1, wherein the illuminating device is formed onto or integrated with the object as part of a molding process.

6. The device of claim 1, wherein the illuminating device protrudes from the cavity.

7. The device of claim 1, wherein the illuminating device is recessed in the cavity.

8. The device of claim 2, wherein the activation device is activated by one of remote control, one or more sensors, and position.

9. The device of claim 8, wherein the activation device is activated by one of acoustic, sound, vibration, optical light, motion, seismic, shock, environmental, moisture, temperature, fluid velocity, angle displacement, distance, speed, and acceleration.

10. The device of claim 1, wherein the one or more LEDs are configured to one of remain in an on state indefinitely, until the power source expires, be turned off and on by an activation, and programmed to blink in a random or predetermined sequence.

11. A method, comprising:
providing an object configured to store a liquid for drinking, the object including a recessed cavity at one end and further including an illuminating device one of attached and integrated into the cavity for lighting the liquid inside the object.

12. The method of claim 11, wherein the illuminating device comprises one or more LEDs that are configured to be activated by an activation device.

13. The method of claim 11, wherein the one or more LEDs are activated by one of pressure, light, sound, the angle of the object, temperature, wireless, voice and radio control.

14. The method of claim 11, wherein the illuminating device is attached to the object by one of adhesive, snapped or locked into place by complimenting nodes or nodules, screwed into place, bundled or held in place by an adhesive film or tape, bonded by heating, fastened into place with nylon plastic straps, wire, and string.

15. The method of claim 11, wherein the illuminating device is formed onto or integrated with the object as part of a molding process.

16. The method of claim 11, wherein the illuminating device protrudes from the cavity.

17. The method of claim 11, wherein the illuminating device is recessed in the cavity.

18. The method of claim 12, wherein the activation device is activated by one of remote control, one or more sensors, and position.

19. The method of claim 18, wherein the activation device is activated by one of acoustic, sound, vibration, optical light, motion, seismic, shock, environmental, moisture, temperature, fluid velocity, angle displacement, distance, speed, and acceleration.

20. The method of claim 11, wherein the one or more LEDs are configured to one of remain in an on state indefinitely, until the power source expires, be turned off and on by an activation, and programmed to blink in a random or predetermined sequence.
